(19) United States
(12) Patent Application Publication
(10) Pub. No.: US 2004/0168279 A1
(43) Pub. Date: Sep. 2, 2004

(54) Equipment and method for changing a blade

(76) Inventors: Ilkka Eskelinen, Jyska (FI); Ari Narhi, Kuopio (FI); Harri Ruotsalainen, Varkaus (FI)

Correspondence Address: STIENNON & STIENNON, 612 W. MAIN ST., SUITE 201, P.O. BOX 1667, MADISON, WI, 53701-1667, US

(21) Appl. No.: 10/479,668

(22) PCT Filed: Jun. 4, 2002
(86) PCT No.: PCT/FI02/00477

(30) Foreign Application Priority Data
Jun. 5, 2001 (FI) 20015006

(51) Int. Cl. B08B 1/00

(52) U.S. Cl. 15/256.53

(57) ABSTRACT

The invention relates to equipment for changing a blade, which blade is intended to be placed in a blade holder (10) and which is preferably arranged as a flexible band (16). The equipment includes reels (14, 15) for keeping the band (16) reeled and transfer devices (18) for moving the band (16) in the blade holder (10) between the reels (14, 15). In addition, the equipment includes guide devices (17) for guiding the band (16) from a reel (14, 15) to the blade holder (10) and vice versa. The guide devices (17) are also arranged to turn the band (16) longitudinally to be essentially parallel to the blade holder (10). The closest guide member (20) of the guide members (20, 20′) belonging to the guide devices (17) is rotated to a position that essentially corresponds to the position of the blade holder (10) turned to the blade-changing position. The invention also relates to a method for changing the blade.

The present invention relates to equipment for changing a blade, which blade is intended for use in connection with doctoring or coating, and which is preferably arranged as a flexible band with one or several blades, the equipment including

a first reel in connection with one end of the blade holder for storing the unused band reeled,

a second reel in connection with the other end of the blade holder for storing the used band reeled,

transfer devices for moving the band in the blade holder between the reels, and

guide devices for guiding the band from the reel to the blade holder and/or from the blade holder to the reel, which guide devices are arranged to turn the band longitudinally to be essentially parallel to the blade holder.

Blades intended for doctoring and coating are used particularly in paper and board machines and in their finishing equipment. Conventionally, blades are changed manually. However, changing long blades is difficult and can even be dangerous. In addition, changing a blade is time consuming. This means that effective production time is reduced, while the blade changing also ties down workers.

Finnish patent number 103596 discloses equipment for changing a doctor blade, in which a band-like blade is fed from a reel to a blade holder and is then pulled from the blade holder onto a second reel. Thus, when changing blades, a band containing several blades can be fed simply with the aid of the operating devices. However, feeding the band by means of the changing equipment described is often difficult, because in reality there is generally little space around the doctor apparatus. The reels must then be located far away from the doctor apparatus, so that the band must be led using complicated guide devices. This makes the changing equipment less reliable and increases the purchase and operating costs of the changing equipment.

The invention is intended to create a new type of equipment, which is simpler and more reliable than previously and by means of which the drawbacks of the state of the art are avoided. The invention is also intended to create a new type of method for changing a blade, which can be applied simply in the various positions that utilize a blade. The characteristic features of the equipment according to the present invention are stated in the accompanying claim 1. Correspondingly, the characteristic features of the method according to the invention are stated in the accompanying claim 8. The use of the equipment according to the invention gives precise control over the blade, without creating peaks of stress that are detrimental to the blade. This is achieved with the aid of simple guide members, which are arranged to operate in stages. At the same time, the equipment is not only versatile, but also clear and reliable in operation. The equipment can be applied in different positions and with different kinds of blade. In the method according to the invention, the blade's natural properties are exploited, permitting the blade to be guided and fed rapidly and safely. The invention also allows a faster blade change than before to be achieved, as the entire production process is controlled in a new manner.

In the following, the invention is examined in detail with reference to the accompanying drawings showing some embodiments of the invention, in which

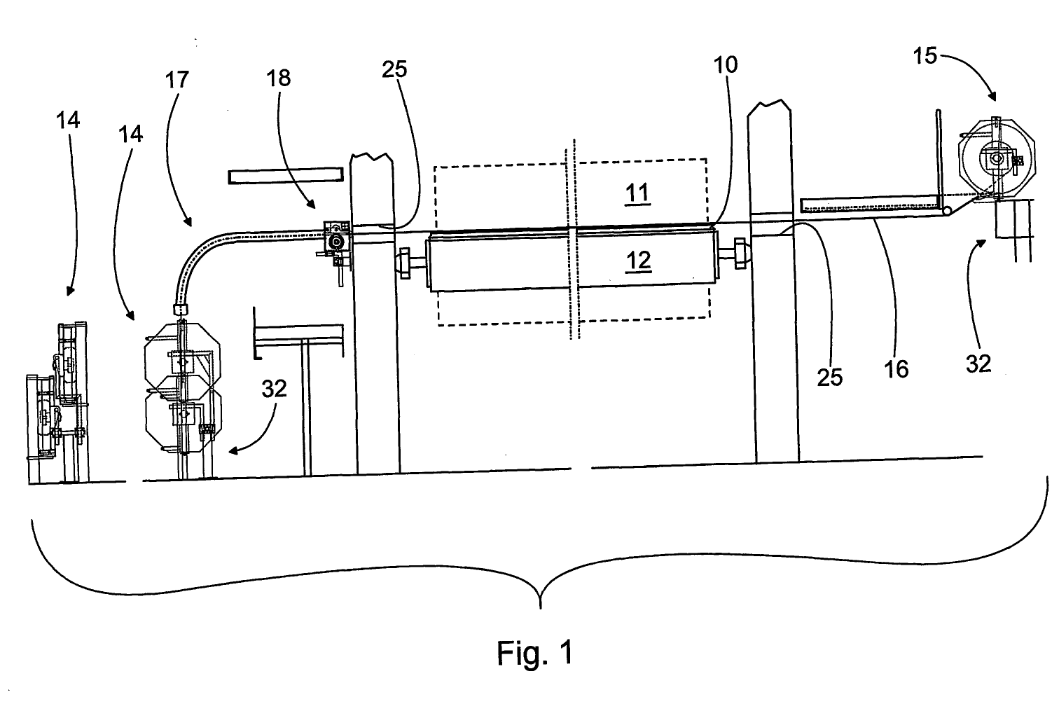

FIG. 1 shows the equipment according to the invention seen from the machine direction and partly seen from the side,

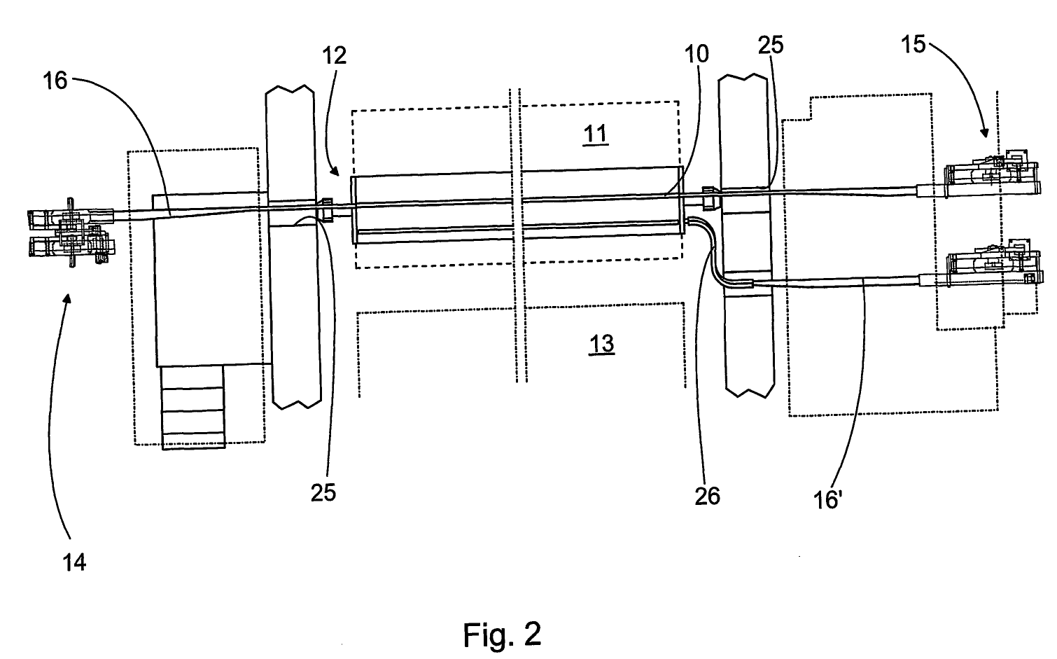

FIG. 2 shows a top view of the equipment of FIG. 1,

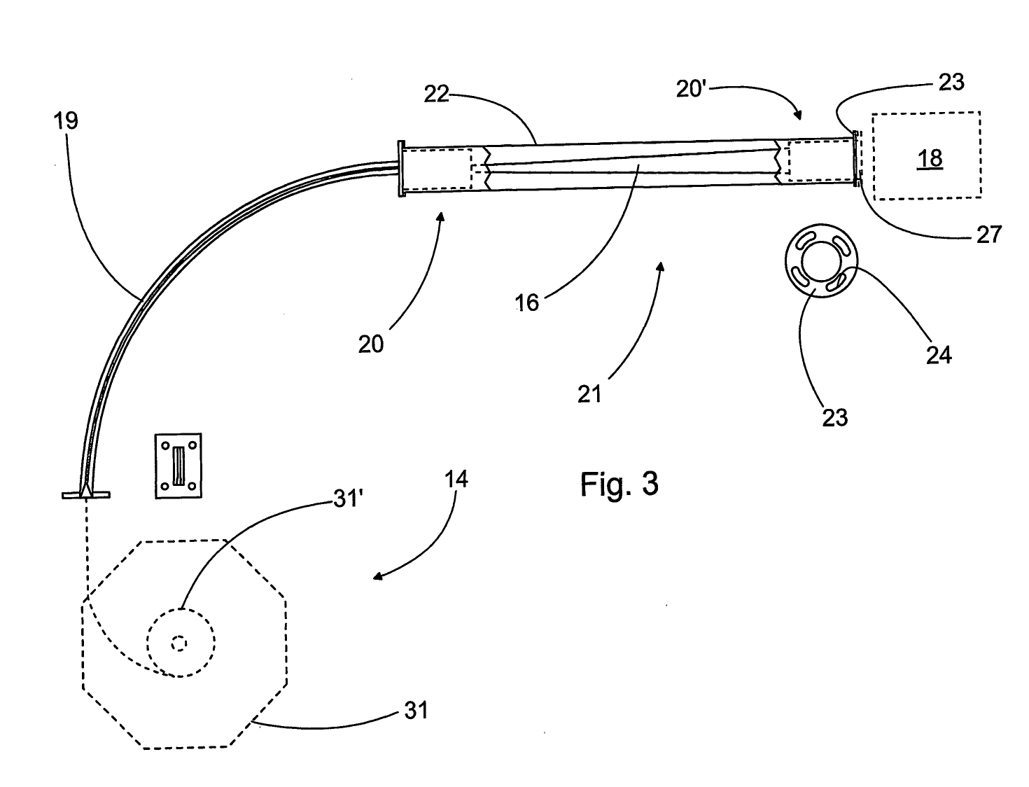

FIG. 3 shows part of the transfer and guide devices according to the invention in partial cross-section,

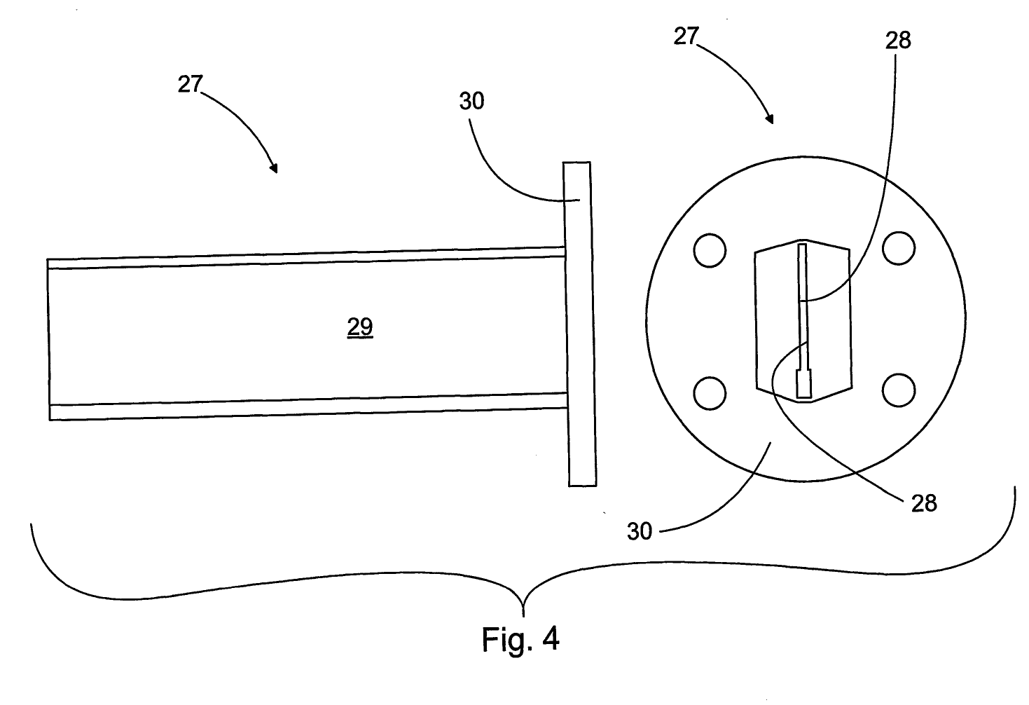

FIG. 4 shows side and front views of the guide member according to the invention,

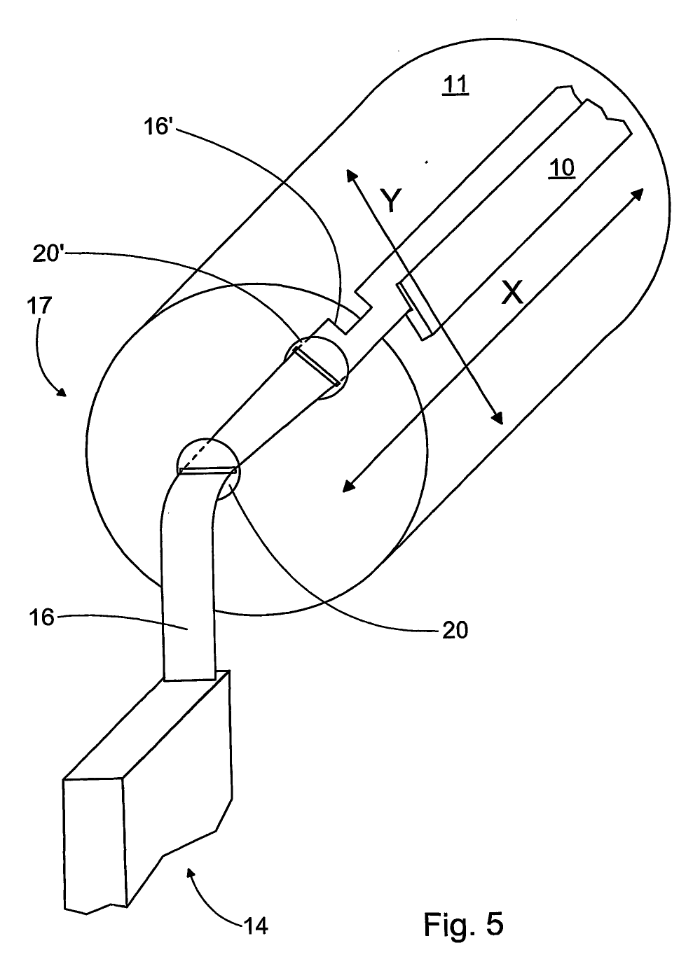

FIG. 5 shows the equipment according to the invention as an axonometric schematic drawing.

FIG. 1 shows the equipment according to the invention for changing a blade. In general, the blade is intended to be used in a blade holder 10, in connection with doctoring or coating. FIG. 1 shows the equipment installed in connection with the double doctor 12 of the centre roll 11 of the press section of a paper machine. FIG. 2 also shows part of a drying cylinder 13 and the centre roll 11 depicted by a broken line. In practice, there is a separate apparatus for each band, the operation of each of which can be controlled independently. In addition to blades intended for doctoring, the equipment can also be used to change, for example, coating and creping blades, depending on the position. To make blade changing faster, use is made of bands formed of one or several blades, which are, as such, known. The material of the band-like blades can also vary in different applications.

In order to change the flexible band-like blade, the equipment of the blade holder 10 includes two reels 14 and 15, according to FIGS. 1 and 2. The first reel 14, on which the unused band 16 is stored reeled, is connected to one end of the blade holder 10. Correspondingly, the second reel 15, on which the used band 16 is stored reeled, is connected to the other end of the blade holder 10. Independent of its use, the band is generally referred to in the drawings using the number 16. In addition, the equipment also includes transfer devices 18 for moving the band 16 in the blade holder 10 between the reels 14 and 15. The transfer devices include feed and pulling devices, such as those disclosed in FI patent 103596, for example. The first reel is preferably located on the tending side and the second on the drive side. This makes it easy to bring a reel containing a new band to the equipment. The used band can be removed from the drive side by changing the filled reel, but the band can also be transferred continuously back to the tending side. In this case, the drive side reel need not be changed. The location and changing of the reels is arranged to suit each operating situation. In FIGS. 1 and 2, the tending side is on the left and the drive side on the right.

The available reels are generally so large that they cannot be fitted right next to the blade holder. It is therefore necessary to place the reels in an otherwise suitable location further from the blade holder. In FIGS. 1 and 2, the tending side reels 14 are in a vertical position, essentially next to the blade holder 10. The band 16 is then led from the reel 14 to the blade holder 10, using the guide devices 17 that form part of the equipment. The drive side guide devices correspondingly lead the band 16 from the blade holder 10 to the reel 15, which is also in a vertical position. The guide devices are thus arranged to turn the band longitudinally essentially parallel to the blade holder, which allows the blade to be transferred to the blade holder.

FIG. 3 shows guide devices according to the invention, to be fitted in connection with the end of the blade holder. First of all, the band 16 is turned longitudinally parallel to the blade holder using a guide 19, which is essentially closed. The start of the guide 19 is connected to the reel 14 and is shaped to correspond to the cross-section of the band. For reasons of clarity, the guide devices in FIG. 3 are shown separately from the other structures. The band 16 is supported in the guide 19 for the whole time, thus preventing the creation of local stress peaks. The guide is preferably of a plastic material, so that there is little friction. According to the invention, the guide devices also include guide members 20 and 20′, which are set a short distance from each other and on the same line. In FIG. 3, the guide 19 is fitted to the first guide member 20. In addition, the band 16 is unsupported between the guide members 20 and 201, permitting the band 16 to rotate freely. This is imperative as the guide member 20′ closest to the blade holder is in a position that is rotated around the longitudinal axis of the band 16, which position essentially corresponds to the position of the blade holder when it is turned to the blade-changing position. Thus, the band, which has been turned longitudinally parallel to the blade holder and essentially led to its location, can be rotated to the alignment of the blade holder. Thus, the band has an unobstructed and flexible path over the entire distance of the equipment. Setting the guide members on the same line avoids the additional stresses arising from torsion.

The angle of the blade holder changes when it is moved from the blade-changing position to the operating position and when the blade wears. The stresses in the band caused by the change of angle can be avoided, for example, by using an edge-slotted band, according to FI patent 103596. The edge slotting also permits the blade holder to oscillate while the band in the rest of the equipment remains stationary.

FIG. 5 shows a schematic drawing of the equipment according to the invention. In this case, the blade holder 10 is depicted in the blade-changing position, in which it is turned away from the surface of the roll 11. As in this position the blade too is off the surface being doctored, not much energy is required to change the blade. During the blade change, the band 16 is fed from the reel 14 to the blade holder 10, through the guide devices 17. In the blade change, the entire blade is changed at one time, there being several blades in a single band 16. First of all, the band 16 is turned with the aid of the guide devices 17 longitudinally essentially parallel to the blade holder 10. This direction is shown by the arrow X in FIG. 5. According to the invention, the guide members 20 and 20′ forming part of the guide devices 17 are used to also rotate the band 16 around its longitudinal axis. In addition, the guide member 20′ closest to the blade holder 10 is unexpectedly arranged to rotate the band 16 to the direction of the blade holder that is turned to the blade-changing position. This direction is shown by the arrow Y in FIG. 5. The equipment can then be used to change the blade simply and reliably by moving the band. After the blade change, the blade holder 10 is pressed back towards the roll 11, when the blade comes against the surface to be doctored. The turning and loading is possible due to the edge slot 16′ arranged in the band. At the edge slot 16′, the band 16 again rotates around its longitudinal axis, permitting wear and even oscillation in the blade while retaining the settings of the guide devices unchanged.

The difference of the rotation angle of the consecutive guide devices in relation to the longitudinal line of the band is preferably 10°-80°, most preferably 20°-60°. The band can then be rotated by a suitable amount at a time. In addition, the farther guide member of the blade holder is usually arranged to guide the band essentially horizontally. Thus, the reel can be located vertically, which is advantageous in terms of the operation and usability of the reel. The band can be rotated, because it is unsupported between the guide members. In this case, the actual guide members are connected by a closed channel 21, thus also protecting the band 16. In principle, the guide members can be supported independently of each other in some other manner. However, it is preferable to use a channel, which has rigidity and a cross-section that is essentially that of a round tube 22, according to FIG. 3. The guide members 20 and 20′ can then be easily attached securely and can be freely rotated.

FIG. 3 also shows the end of the tube 22 seen from the direction of the tube 22. The guide members 20 and 20′ are shown by broken lines. In this case, there is a flange 23 at the end of tube 22, in which there are attachment holes 24 that permit a change in angle. Thus, the guide member 20′ can be attached simply with bolted connections and can also rotate within the tube 22 to the desired angle. There is preferably also a corresponding flange at the other end of the tube 22, allowing the difference of angle between the guide members 20 and 20′ to be adjusted precisely. The guide devices 17 are preferably attached directly to the transfer devices 18 and from there on through the pull-through opening 25 to the blade holder 10 (FIG. 1). In principle, the guide devices are the same on both the tending and the drive sides. As there is usually less installation space on the drive side than on the tending side, the shape of the guide devices may differ. In FIG. 3, the tube 22 is shown in partial cross-section, so that the rotation of the band 16 is clearly visible.

FIG. 2 also shows the construction of the drive side guide devices in greater detail. Due to the lack of space, the second band 16′ is guided after the blade holder 10 by means of a special guide tube 26. The guide tube is made from plastic and creates a displacement in a single direction, after which there are guide members according to the invention (not shown). In other words, at the outer end of the guide tube the band is still parallel to the blade holder. The guide members are then used to turn the band once again to the horizontal direction and guide it to the reel. In FIG. 2, the second reel 15 could be installed right next to the blade holder 10, thus making the guide tube unnecessary in the position in question. The reel 15 in question is also shown in FIG. 1.

The distance required to rotate the band varies mainly according to the dimensions and material of the band. Usually, the distance between the guide members is 4-16, preferably 8-12 times the width of the band. The stresses within the band will then remain within the permitted limits while the equipment remains advantageously small. In one set of equipment according to the invention, the distance between the guide members is about 700 mm. Operationally reliable and simple guiding is achieved by means of a nozzle, in which there is a flat support surface at least on two opposing sides of the band. Such a nozzle 27 forming a guide member 20 or 20′ is shown in FIG. 4. Here, the nozzle 27 includes a body 29, which has support surfaces 28 shaped like the cross-section of the band. A flange 30 is also attached to the body 29, with the aid of which the nozzle 27 is secured to the flange 23 (FIG. 3) at the end of the tube 22. The nozzle is of a plastic material, preferably polyethylene or a similar plastic material. Plastic is highly durable in use, as the transfer speed of the band is low and the equipment operates in stages. In addition, there is little friction between the blade, which is made of a composite material, and polyethylene. The nozzle can be manufactured simply by extrusion. In addition, the closed construction of the equipment prevents the equipment and especially the band from being dirtied. On the other hand, band washing devices (not shown) can be located, for example, after the nozzle.

In the simplest form, there are two nozzles. In addition, the length of each nozzle is 1-6, preferably 2-4 times the width of the band. This means that the equipment is compact, but creates sufficient support for the band. As the friction is low, the support surfaces of the nozzle can be made wide. If necessary, several guides and guide members according to the invention can be joined in sequence. This is a significant advantage, particularly on the drive side. For example, the guide tube described above can be replaced with guide members and guides, in such a way that after the blade holder guide members are used to first of all rotate the band to the horizontal and then guides are used to turn it downwards. After this, guide members are once again used to rotate the band a second time, for example, through 90° and guides are again used to turn it to the machine direction. Thus the reel can still be set in a vertical position, but sideways in relation to the blade holder. By alternatively rotating the band and using guides or other means to turn it through a specific radius, the reel can if necessary be located at the side of the blade holder. The figures, however, show one of the most advantageous alternative embodiments.

The band is fed using transfer devices. The transfer devices are preferably fitted as close to the blade holder as possible. In the equipment according to the invention, hydraulic motors are used in the transfer devices. In addition, there are hydraulic motors in each reel, the operation and control of which are connected in parallel with the hydraulic motors of the transfer devices. In other words, when changing the blade, the band is moved using the transfer devices. At the same time, the hydraulic motor of the tending side reel can rotate freely and, when a sensor belonging to the equipment detects that the band has slackened, the hydraulic motor of the drive side reel begins to pull the band. This arrangement prevents the band from being broken and achieves a precise band transfer. Some other suitable power source can be used besides or instead of the hydraulic motors.

The reels 14 and 15 shown in the figures incorporate an octagonal casing 31, inside which there is a hub 31′ that is supported so that it can rotate. The band 16 is reeled onto the hub 31′, to which the hydraulic motor is connected. In the figures, each reel is supported on a separate support 32, but the entire equipment can be manufactured as a compact construction, which has a correspondingly shaped recess with the hydraulic motors. In that case, a new reel is simply placed in the recess, when the shape will lock the reel in place and the hydraulic motor will be connected to the hub of the reel.

According to the method according to the invention the guide devices are used to support the band, which has been rotated essentially parallel to the blade holder, from two points set at a distance to each other. Between these points, the band is rotated in relation to its longitudinal axis to a position essentially corresponding to the position of the blade holder when it is turned to the blade-changing position. When changing the blade, the transfer of the band is then unimpeded and the transfer requires little power, which in turn reduces the probability of the band being broken. FIG. 2 shows the rotation of one band 16 on both the tending and drive sides. The rotation of the second band 16′ is shown only on the drive side. In order to illustrate this, FIG. 2 does not show the guide and transfer devices.

The method according to the invention can be advantageously used especially in a paper machine. The same advantage can also be achieved in board and similar web-forming machines. A paper machine comprises consecutive, operationally independent sections (not shown) equipped with doctoring apparatuses. If necessary, the web can be run down between sections. Such a situation occurs, for example, during a blade change or a web break. According to the invention, when a blade change is commenced, the web is run down from the section of the paper machine preceding the independent section of the paper machine in which the doctoring apparatus is located. Simultaneously, the said first section is run at production speed without the web. The use of the method in question achieves an important advantage especially in the paper machine's press section, in which the blade of the centre roll's doctor apparatus, which preferably has two blades, is being changed. The web section is then run normally, but the web is run down into the pulper. At the same time, the blade holders of press section's doctor apparatuses are turned to the blade-changing position, while the press section continues to run at production speed, but without the web. The blade is changed using the equipment according to the invention. After the blade change, the blade holders are turned to the operating position and the web is guided onto the press section. This avoids stopping and restarting the press section, thus cutting the changing time to less than half of that known. This increases the effective production time of the paper machine, especially when using blades that wear rapidly.

The equipment according to the invention is very suitable for different kinds of positions and blades. The equipment can also be easily retrofitted, though the most suitable locations for the reels can be selected when designing a new machine. The equipment is light and safe to use, thanks to the remotely-controlled operating devices. The unimpeded transfer of the band and the small stresses imposed on the band are also important. Correspondingly, blade changing is considerably accelerated with the aid of the method according to the invention.

1. Equipment for changing a blade, which blade is intended to be used in a blade holder (10) in connection with doctoring or coating a surface, and which is preferably arranged as a flexible band (16) with one or several blades, the equipment including
a first reel (14) in connection with one end of the blade holder (10), for keeping the unused band (16) reeled,
a second reel (15) in connection with the other end of the blade holder (10), for keeping the used band (16) reeled,
transfer devices (18) for moving the band (16) in the blade holder (10) between the reels (14, 15), and
guide devices (17) for guiding the band (16) from a reel (14, 15) to the blade holder (10) and/or from the blade holder (10) to a reel (14, 15), which guide devices (17) are arranged to turn the band (16) longitudinally to be essentially parallel to the blade holder (10),
characterized in that the guide devices (17) also include guide members (20, 20′) set on the same line at a distance to each other, between which the band (16) is unsupported, and the guide member (20′) closest to the blade holder (10) is in a position rotated in relation to the longitudinal axis of the band (16), which essentially corresponds to the position of the blade holder (10) turned to the blade-changing position, in which position the blade is off the surface being doctored or coated.

2. Equipment according to claim 1, characterized in that the difference of the angle of rotation of the consecutive guide members (20, 20′) in relation to the longitudinal line of the band (16) is 10°-80°, preferably 20°-60°, the guide member (20) farthest from the blade holder (10) being arranged to guide the band (16) essentially horizontally.

3. Equipment according to claim 1 or 2, characterized in that the distance between the guide members (20, 20′) is 4-16, preferably 8-12 times the width of the band (16).

4. Equipment according to any of claims 1-3, characterized in that the guide members (20, 20′) are connected by a closed channel (21), which is preferably a rigid tube (22) with an essentially round cross-section.

5. Equipment according to any of claims 1-4, characterized in that each guide member (20, 20′) is a nozzle (27), in which there is a flat support surface (28) at least on the two opposing sides of the band (16).

6. Equipment according to claim 5, characterized in that the nozzle (27) is of a plastic material, preferably polyethylene or a corresponding plastic material.

7. Equipment according to claim 5 or 6, characterized in that there are two nozzles (27) and the length of each nozzle (27) is 1-6, preferably 2-4 times the width of the band (16).

8. A method for changing a blade, in which method a flexible band (16) formed of one or several blades used in connection with doctoring or coating a surface, which, when the entire blade is changed at one time in the blade holder (10), is moved using transfer and guide devices (18, 17), in such a way that the guide devices (17) are used to turn the band (16) essentially parallel to the blade holder (10), characterized in that, in addition to turning, the band (16) is supported at two points set at a distance to each other, between which the band (16) is rotated to a position relative to its longitudinal axis that essentially corresponds to the position of the blade holder (10) when turned to its blade-changing position, in which position the blade is off the surface being doctored or coated.

9. A method according to claim 8 in a paper machine which includes consecutive, operationally independent sections equipped with doctoring apparatuses (12), between which the web is run down if necessary, characterized in that, when the blade change is commenced, the web is run down from the independent section of the paper machine preceding the section in which the doctoring apparatus (12) is located, when the said first section is run at production speed without the paper web.

10. A method according to claim 9 in a paper machine, characterized in that the doctoring apparatus (12) is fitted to the press section of the paper machine, the blade of the doctoring apparatus (12) of the centre roll (11), containing preferably two blades, is changed.
